(19) United States
(12) Patent Application Publication
(10) Pub. No.: US 2026/0101921 A1
(43) Pub. Date: Apr. 16, 2026

(54) Automatic egg peeling machine

(71) Applicant: Dingyuan Wang, Chengdu (CN)

(72) Inventor: Dingyuan Wang, Chengdu (CN)

(21) Appl. No.: 18/917,808

(22) Filed: Oct. 16, 2024

(30) Foreign Application Priority Data
Oct. 10, 2024 (CN) 2024114053239

(51) Int. Cl. A23P 30/00

(52) U.S. Cl. CPC A23P 30/00

(57) ABSTRACT

The invention discloses an automatic egg peeling machine, which comprises a base and a peeling mechanism, wherein the peeling mechanism comprises a shell and an egg peeling roller. The shell is installed on the base, and an egg peeling track is provided in the shell. The upper end and the lower end of the shell are respectively provided with a feeding opening and a discharging opening communicating with the egg peeling track. The egg peeling roller is installed on one side of the egg peeling track, the surface of the egg peeling roller is provided with a spiral conveying ridge, and the surface of the egg peeling roller is also provided with a plurality of crushing ridges and friction ridges, which are arranged between the conveying ridges. This design is compact in size, simple and clever in structure, suitable for household use, and greatly improves the speed of egg peeling.

### TECHNICAL FIELD

The invention relates to the technical field of household electrical appliances, in particular to an automatic egg peeling machine.

### BACKGROUND OF THE INVENTION

Eggs are a kind of nutritious food. The protein in eggs is high-quality protein. The amino acid composition is similar to the needs of human body, and the absorption and utilization rate is high, which helps to promote growth and development, maintain muscle function and provide energy. The eggshell on its surface need to be removed before consuming the cooked egg.

The invention patent with authorization announcement number CN215457137U discloses a domestic rotary egg peeler, which includes a base. The top of the base is fixedly connected to a processing table, and one side of the processing table is rotatably connected to a second rotating shaft. One end of the second rotating shaft is fixedly connected to a processing ball, and the interior of the processing table is provided with a rotating component that rotates the second rotating shaft. The processing ball is a hollow structure. In this scheme, the semicircular protrusion crushes the eggshell by rotating the processing ball, so as to peel the eggshell, and there is no need to use rubber products without worrying about its aging and damage. Peeling the shell by the semicircular protrusion of about 1 mm can prevent the egg body from being damaged after the eggshell peels off. By processing the shape of the ball into a spherical one, the egg can more fully contact with the inner wall of the sphere when rolling, reduce the peeling time and increase the peeling efficiency at the same time. However, this scheme uses manual rotating shaft to peel eggs, which is laborious and inefficient, while the industrial egg peeling machine in factory has a huge structure and is inconvenient to use at home.

### SUMMARY OF THE INVENTION

In order to solve the above problems, the invention provides a household egg peeling machine with simple and ingenious structure, which greatly improves the speed of peeling eggs.

Theautomatic egg peeling machine comprises a base and a peeling mechanism. The peeling mechanism comprises a shell and an egg peeling roller, the shell is installed on the base, and an egg peeling track is provided in the shell. The upper end and the lower end of the shell are respectively provided with a feeding opening and a discharging opening communicating with the egg peeling track. The egg peeling roller is installed on one side of the egg peeling track, and the surface of the egg peeling roller is provided with a spiral conveying ridge. The surface of the egg peeling roller is also provided with a plurality of crushing ridges and friction ridges, which are arranged between the conveying ridges. When the egg peeling roller rotates in the axial direction, the channel between the spiral conveying ridges can push the eggs in the egg peeling track to travel, and the crushing ridges arranged between the conveying ridges realize the knocking effect on the eggs to make the eggshells crack. Moreover, he friction ridges on the surface of the egg peeling roller play a friction effect on the cracked eggshells, thus pulling the eggshells to fall off.

Further, the egg peeling roller is composed of a shaft body and an outer sleeve. It is sleeved on the shaft body, two ends of the shaft body are provided with stainless steel rotating shafts, and the surface of the outer jacket is provided with the conveying convex, crushing convex and friction convex. Wherein, the shaft body adopts a food-grade plastic shell, and the outer sleeve adopts food-grade silica gel. Both the shaft body and the outer sleeve can be produced by an injection molding process, which can greatly reduce the production cost of the egg peeling roller, and is convenient for assembly, disassembly, cleaning or replacement.

Further, the surface of the conveying convex has a continuous wavy shape, so that the egg peeling roller can contact the egg as much as possible, which is convenient to push the egg forward. The crushing convex is in the shape of a long strip, which is convenient for squeezing the egg shell. The friction convexity is densely distributed in the shape of circular dots, and the friction force is increased to facilitate peeling off the egg shell.

Furthermore, the peeling mechanism also comprises a peeling motor, which is installed in the housing and can be connected to drive the egg peeling roller to rotate.

Further, in order for the eggs in the egg peeling track to be better pushed forward along the egg peeling roller, a plurality of passive rollers are also installed in the shell. The passive rollers are arranged on the egg peeling track and used to support the eggs in the egg stripping track, and when the eggs are pushed forward along the egg peeling roller, the passive rollers can freely rotate. Moreover, the contact surface with the eggs is small, thereby reducing the friction of the eggs during travel. The shell is also equipped with an active roller, which is arranged on the other side of the egg peeling track opposite to the egg stripping roller. The shell peeling motor is connected and can drive the active roller to rotate synchronously with the egg stripping roller, so that it will push the eggs on the egg stripping track when the active roller rotates, promoting the movement and shell stripping of the eggs.

Furthermore, there is a high probability that the egg will jump upwards due to the compressed state of the egg during peeling. Therefore, an elastic pressure plate is also installed in the shell of this design, which is located above the egg stripping track. The upper end of the elastic pressure plate is provided with a guide column, which is equipped with an anti-detachment elastic card block. The shell is equipped with a guide groove that matches the guide column, and a spring is also connected between the elastic pressure plate and the shell. Under the action of the spring, the elastic pressure plate will press the egg in the egg peeling track downward so that it will not jump up, realizing more effective operation on the egg peeling track after it is applied pressure, making the operation efficiency higher and the egg peeling effect better. Wherein, the bottom surface of the elastic pressing plate is in an arc shape matching the contour of the egg, and the front end of the elastic pressing plate is in a tilted inclined shape. So, the egg can more easily enter the pressure application area of the elastic pressing plate by adopting such an arc-shaped, progressive, and elastic pressing plate mode. A plurality of evenly distributed particle points are arranged on the bottom surface of the elastic pressing plate, which plays a role of friction on the eggs, and makes the elastic pressing plate more effectively control the travel of the eggs.

Furthermore, the upper end of the shell is also equipped with an egg tray connected to the feeding port for discharging eggs to be peeled; A flap egg separator is installed at the feed inlet, and the flap egg separator comprises a central axis. The two ends of the central axis are rotatably connected to the housing, and four flip plates are uniformly distributed on the circumference of the central axis. Before the egg rolling to the feed port on the egg bracket, the egg flap advancement is automatically realized by the automatic rolling forward force of the egg, and the traveling process of the egg is cut off one by one, effectively avoiding the crowding and blockage of the egg. Wherein, in order to facilitate the rolling of eggs, the egg bracket is arranged in a downward and inclined shape along the direction of the feeding port. In order to avoid the egg falling into the egg peeling track from the flap on the front side, the axial outer dimension of the flap is set to be smaller than its vertical outer dimension.

Further, an eggshell collection box and an egg collection box are arranged in the base. The eggshell collection box is arranged below the egg peeling roller, the egg collection box is arranged below the discharge port, and they are detachably installed in the base.

Further, the bottom of the base is provided with a plurality of colloidal pads, and the vibration and noise can be effectively reduced when the machine is placed on the table for operation.

The beneficial effect of the present invention is that the design is compact in size, simple and ingenious in structure, suitable for home use, greatly improving the speed of peeling eggs.

### BRIEF DESCRIPTION OF THE DRAWINGS

FIG. 1 is an overall structural perspective view of the present invention;

FIG. 2 is a structural perspective view of a default upper housing according to the present invention;

FIG. 3 is a structural perspective view of the shelling mechanism according to the present invention.

FIG. 4 is a schematic diagram of the internal structure of the peeling mechanism of the present invention;

FIG. 5 is a schematic diagram of the structure of the egg stripping roller of the present invention;

FIGS. 6 and 7 are schematic diagrams of the structure of the elastic pressure plate of the present invention;

FIGS. 8, 9 and 10 are schematic structural diagrams of the flip egg spacer according to the present invention;

FIGS. 11-13 are schematic views of the present invention in use.

### DETAILED DESCRIPTION OF THE INVENTION

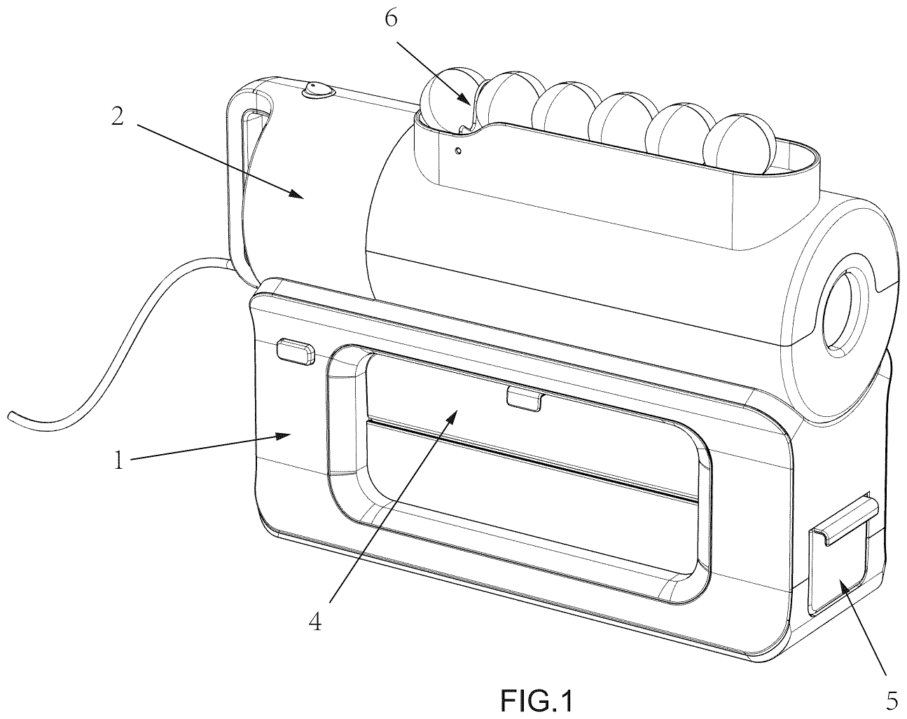

The present invention will be further described below with reference to the accompanying drawings. The specific embodiments are representatives of the present invention, and the specific methods, devices, conditions, materials, etc. cited therein are not intended to limit the present invention or the corresponding specific embodiments. For the description of azimuth in this paper, FIG. 1 is used as a reference standard.

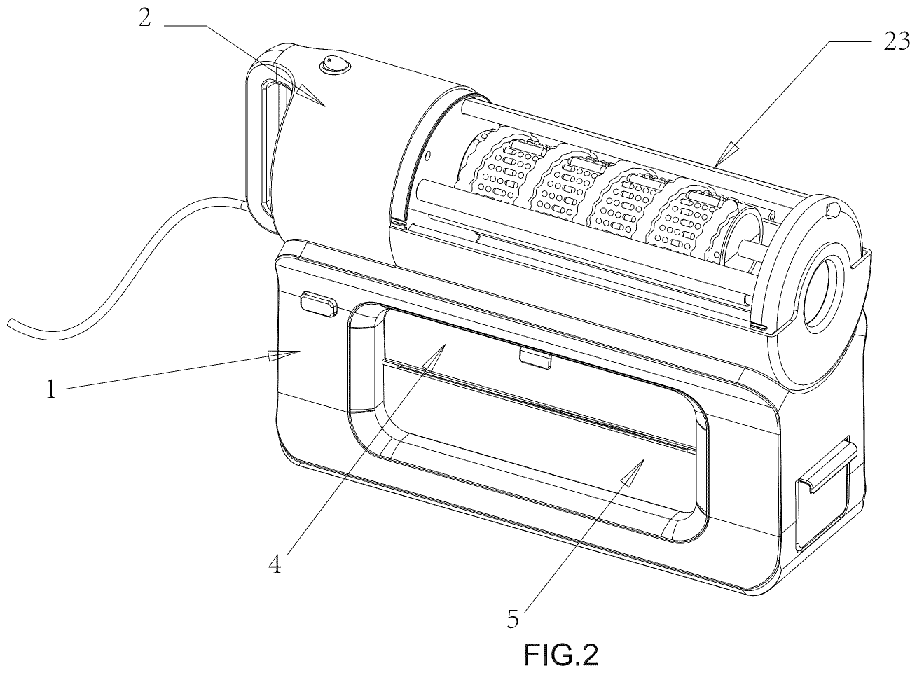

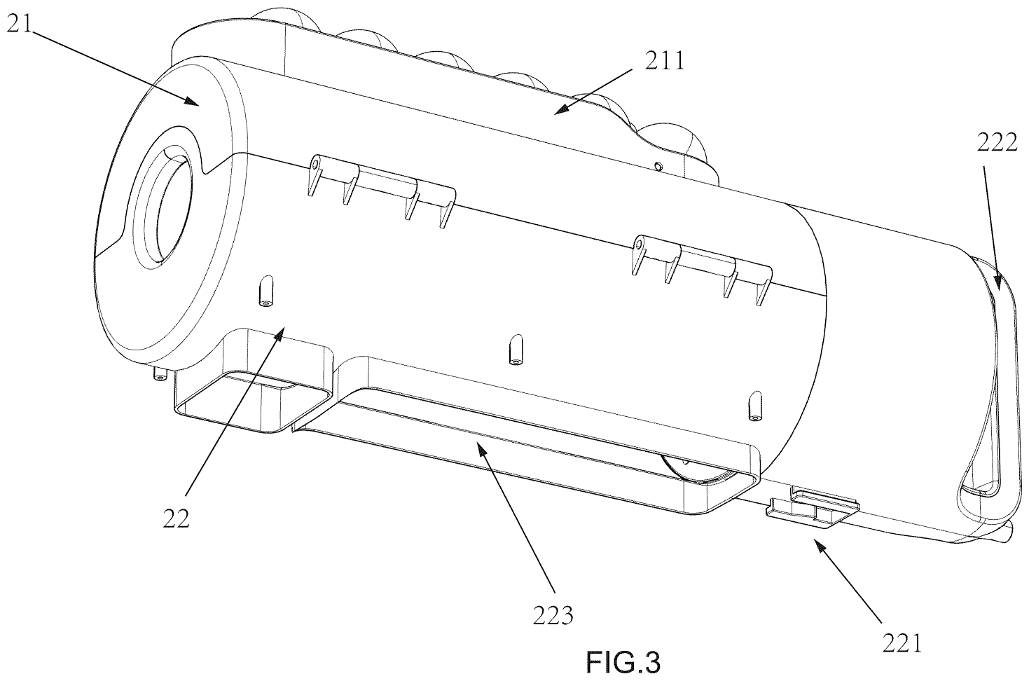

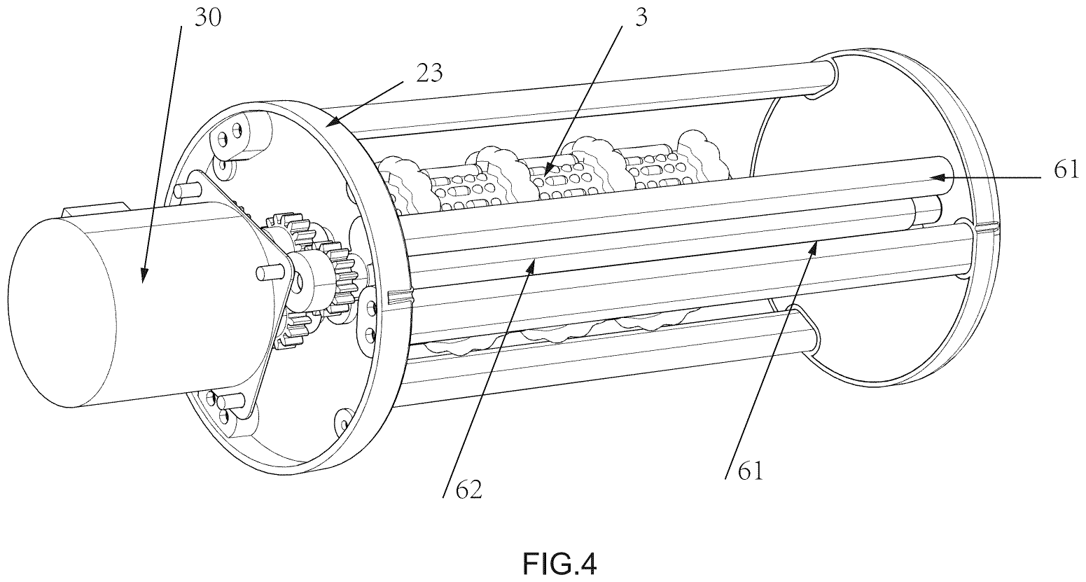

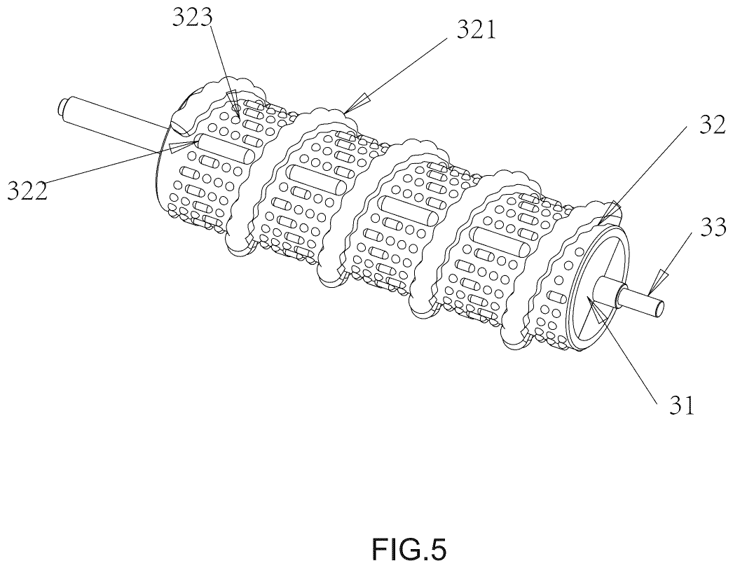

As shown in FIGS. 1 to 4, the automatic egg peeling machine includes a base 1 and a shelling mechanism 2, and the shelling mechanism 2 is detachably mounted on the base 1. The shelling mechanism 2 includes a shell and an egg peeling roller 3, the shell is composed of an upper shell 21, a lower shell 22 and a bracket 23. The lower shell 22 is fixedly installed on the base 1, one end of the upper shell 21 and the lower shell 22 is connected in a hinged way to form an opening and closing structure. Moreover, the bracket 23 is detachably installed between the upper shell 21 and the lower shell 22. The bracket 23 is provided with a buckle 221, so that the shelling mechanism 2 can be snapped into the base 1 with one button to complete the assembly of the two. The two can also be easily disassembled for convenient cleaning and maintenance. The front end of the bracket 23 is also provided with a handle 222, which is convenient for holding and using. The upper end of the upper shell 21 is provided with an egg bracket 211 for discharging eggs to be shelled, the upper end of the upper shell 21 is also provided with a hollowed-out feeding port at the end of the egg bracket 211, and the lower end of the lower shell 22 is provided with a discharging port 223 for discharging eggs and eggshells after shelling. The shell is provided with an egg peeling track. A plurality of passive rollers 61, a driving roller 62, a shell peeling motor 30 and the egg peeling roller 3 are also installed on the bracket 23. The egg peeling roller 3 is placed on the right side of the egg peeling track, the number of passive rollers 61 is two in this embodiment. One passive roller 61 is arranged on the bottom side of the egg peeling track, one passive roller 61 is arranged on the left side of the egg peeling track, and the active roller 62 is arranged between the two passive rollers 61. The passive roller 61 and the active roller 62 support the eggs in the egg peeling track, so as to ensure that the eggs can be pushed along the egg peeling roller 3 and advance to the discharging port 223. The passive roller 61 can rotate freely and has a small contact surface with the egg, thereby reducing the friction of the egg during travel. The shell stripping motor 30 is connected to the active roller 62 and the egg stripping roller 3 through a gear mechanism, and can drive the active roller 62 to rotate synchronously with the egg stripping roller 3. By doing so, it will push the eggs on the egg stripping track when the active roller 62 rotates, promoting the movement and peeling of the eggs. As shown in FIG. 5, the egg peeling roller 3 is composed of a shaft body 31 and an outer sleeve 32. The outer sleeve 32 is sleeved on the shaft body 31, and the two ends of the shaft body 31 are provided with stainless steel rotating shafts 33. Wherein the stainless steel rotating shaft 33 at the front end is a short shaft to connect the shelling motor 30, and the stainless steel rotating shaft 33 at the rear end is a long shaft to connect the bracket 23. The purpose of selecting the long shaft is to reserve enough position to facilitate the peeled eggs to have enough space to roll off from the discharging port 223. The surface of the outer sleeve 32 is provided with spiral-shaped conveying ridges 321, and the surface of the outer sleeve 32 is further provided with a plurality of crushing ridges 322 and friction ridges 323 arranged between the conveying ridges 321. The crushing ridges 322 and friction ridges 323 are arranged between the conveying ridges 321, and the surface of the outer sleeve 32 is also provided with a plurality of crushing ridges 322 and friction ridges 323, which are arranged between the conveying ridges 321. When the egg stripping roller 3 of this design rotates axially, the channels between its spiral conveying protrusions 321 can push the eggs in the egg peeling track to move. It is arranged between the conveying protrusions 321 to crush the protrusions 322 and achieve a striking effect on the egg during the movement of the egg, causing the eggshell to rupture. The friction ridges 323 on the surface of the egg stripping roller 3 exert a frictional effect on the broken eggshell, pulling it apart and causing it to fall off.

Further, the shaft body 31 is made of a food-grade plastic shell, and the outer sleeve 32 is made of food-grade silica gel. Both the shaft 31 and the sleeve 32 can be produced by an injection molding process, which can greatly reduce the production cost of the egg peeling roller and facilitate assembly as well as disassembly for cleaning or replacement.

Further, the surface of the conveying convex 321 has a continuous wavy shape, so that the egg peeling roller can contact the eggs as much as possible, which is convenient to push the eggs forward. The crushing convex 322 is in the shape of a long strip, which is convenient for squeezing the egg shell. The friction convexity 323 is densely distributed in the shape of circular dots, and the friction force is increased to facilitate peeling off the egg shell.

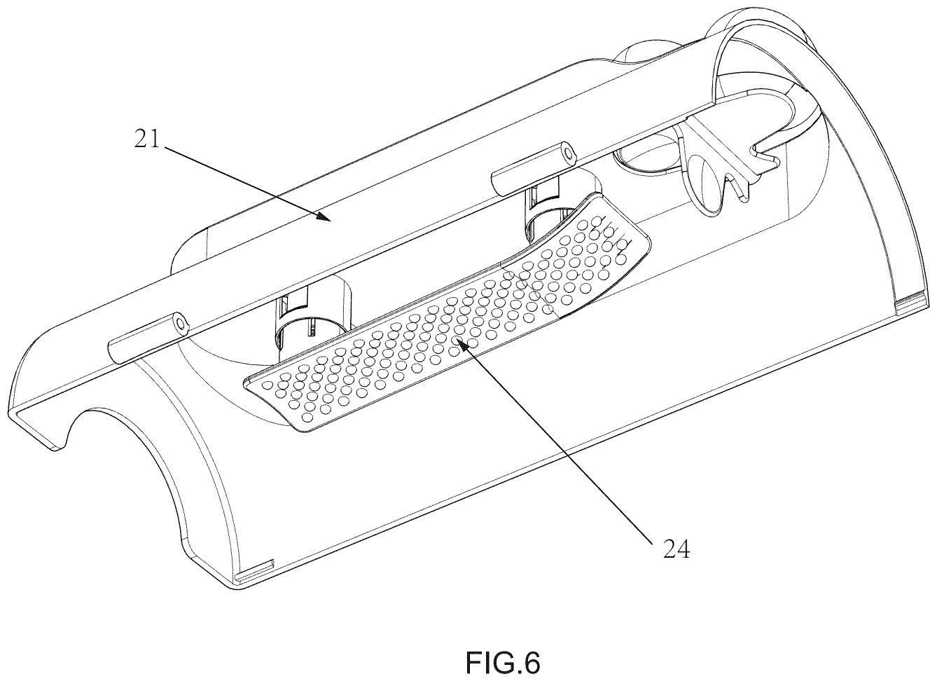

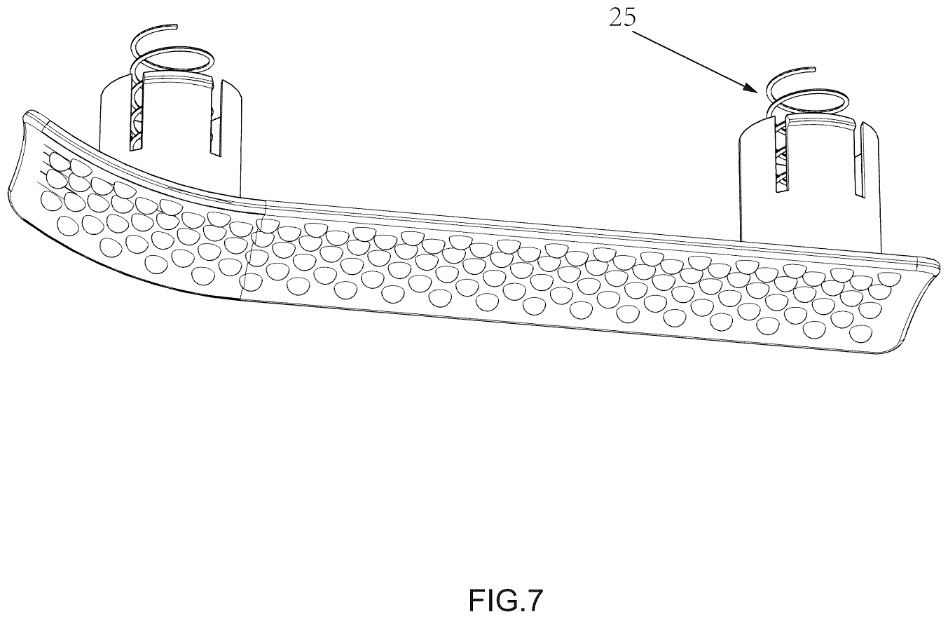

Furthermore, as shown in FIGS. 6 and 7, there is a high probability that the egg will jump upwards due to the compressed state of the egg during peeling. Therefore, the upper shell 21 of this design is also equipped with an elastic pressure plate 24, which is located above the egg stripping track. The upper end of the elastic pressure plate 24 is provided with two guide posts, and anti-detachment elastic blocks are provided on the two guide posts. The upper shell 21 is equipped with a guide groove matching the guide column, and a spring 25 is also connected between the elastic pressure plate 24 and the upper shell 21. Under the action of the spring 25, the elastic pressure plate 24 will press the egg in the egg peeling track downward so that it will not jump up, realizing more effective operation on the egg peeling track after it is applied pressure, and making the operation efficiency higher and the egg peeling effect better. Wherein, the bottom surface of the elastic pressing plate 24 is in an arc shape matching the contour of the egg, and the front end of the elastic pressing plate 24 is in a tilted inclined shape. So, the egg can more easily enter the pressure application area of the elastic pressing plate by adopting such an arc-shaped, progressive, and elastic pressing plate mode. A plurality of evenly distributed particle points are arranged on the bottom surface of the elastic pressing plate 24, which plays a role of friction on the eggs, and makes the elastic pressing plate more effectively control the travel of the eggs.

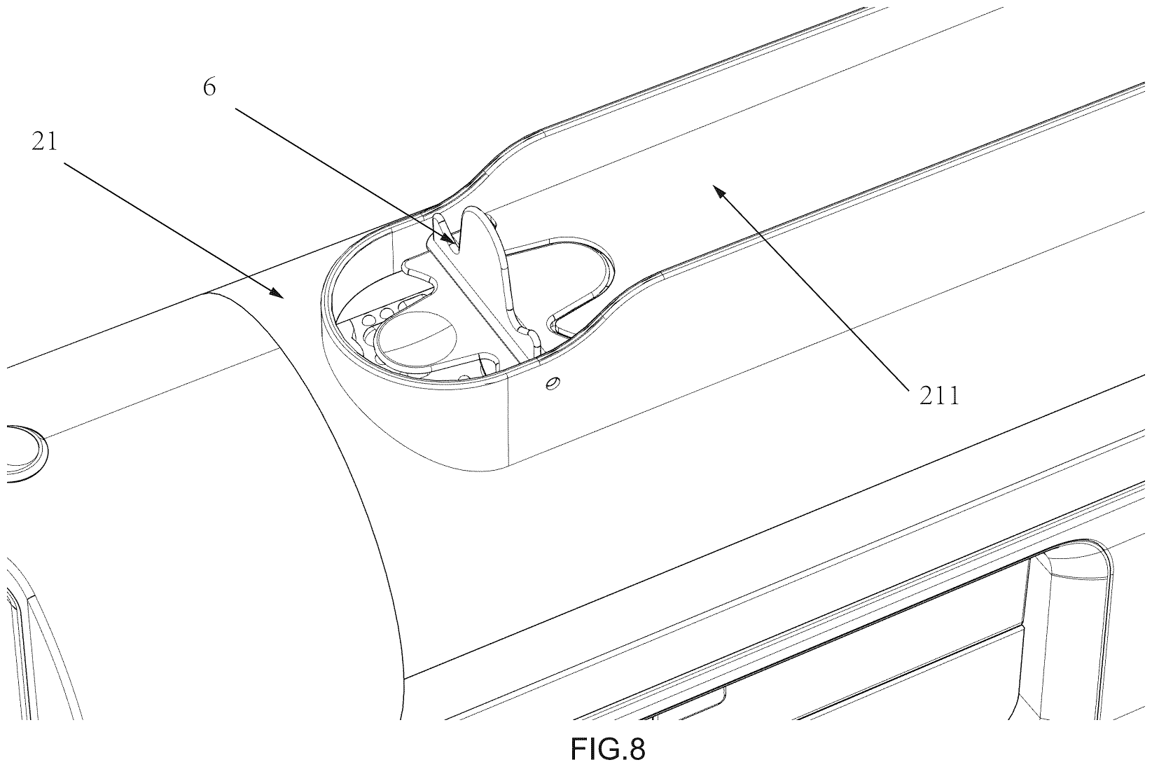

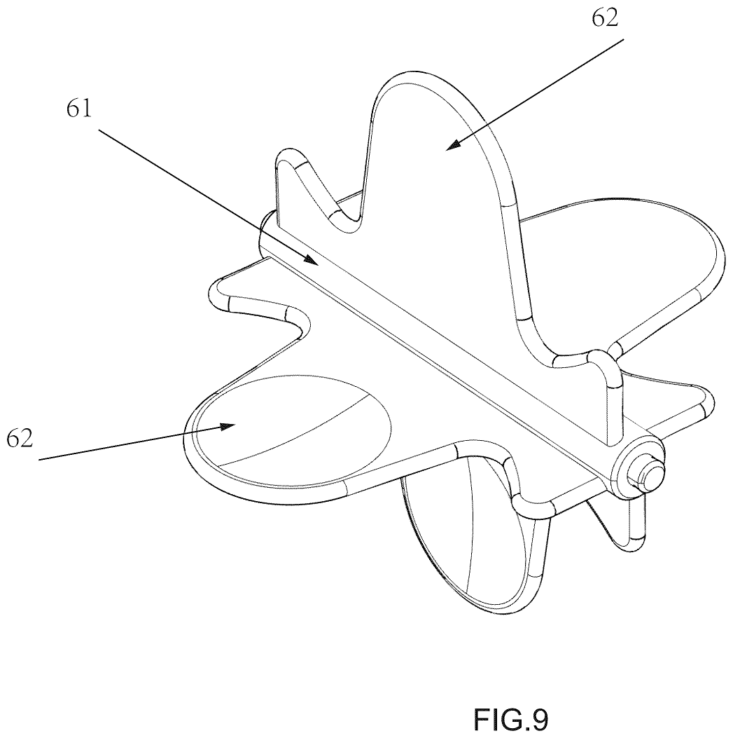

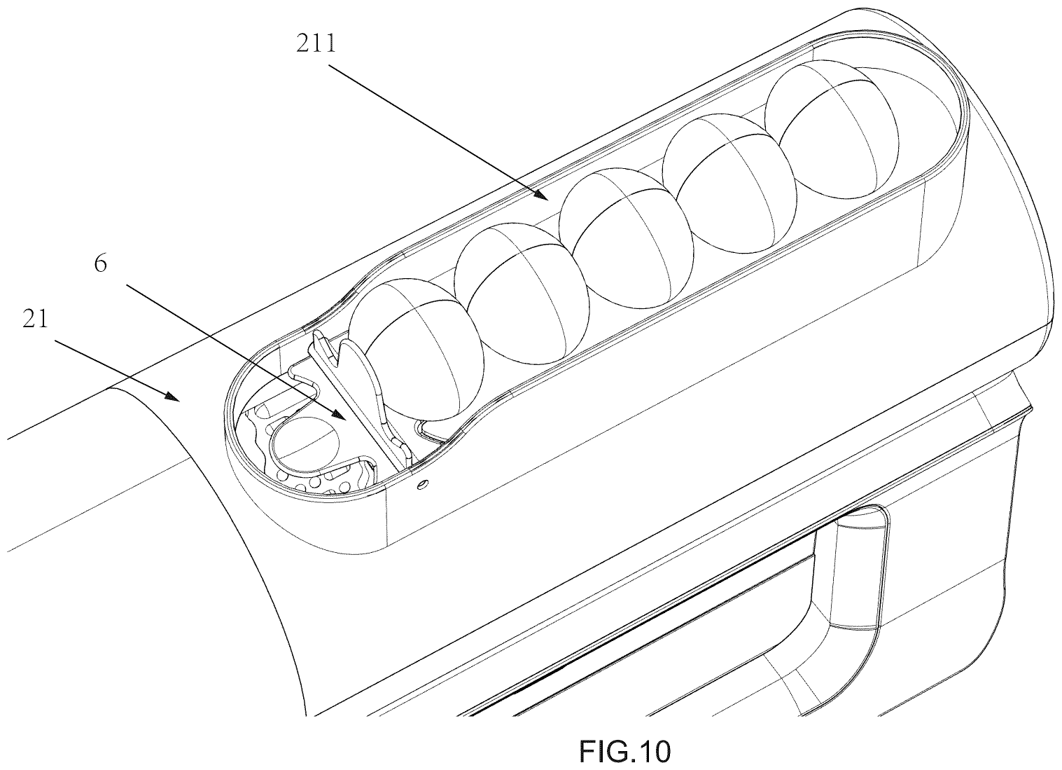

Further, as shown in FIG. 8, a flap egg separator 6 is installed at the feeding port. As shown in FIG. 9, the flap egg separator 6 includes a central axis 61, and the two ends of the central axis 61 are rotatably connected to the upper shell 21. Four flipping plates 62 are uniformly distributed on the circumference of the central axis 61. A flap structure composes four 90 degree combinations. The automatic rolling forward force of the egg automatically achieves the flipping and pushing of the egg after the egg rolls to this place. This will block the movement of the eggs one by one, effectively avoiding their overcrowding and blockage. Wherein, in order to facilitate the rolling of eggs, the egg bracket 221 is arranged in a downward and inclined shape along the direction of the feeding port. As shown in FIG. 10, in order to prevent eggs from falling into the egg peeling track from the front flap, the axial outward dimension of the flap 62 is set to be smaller than the vertical outward dimension of the eggs. In order to prevent eggs from rolling outward uncontrollably during turning, the flap plate 62 is also provided with an arc-shaped groove.

Further, an eggshell collection box 4 and an egg collection box 5 are arranged in the base. The eggshell collection box 4 is arranged below the egg peeling roller 3, the egg collection box 5 is arranged below the discharge port 223, and they are detachably installed in the base1.

Further, the bottom of the base 1 is provided with a plurality of colloidal pads, and the vibration and noise can be effectively reduced when the machine is placed on the table for operation.

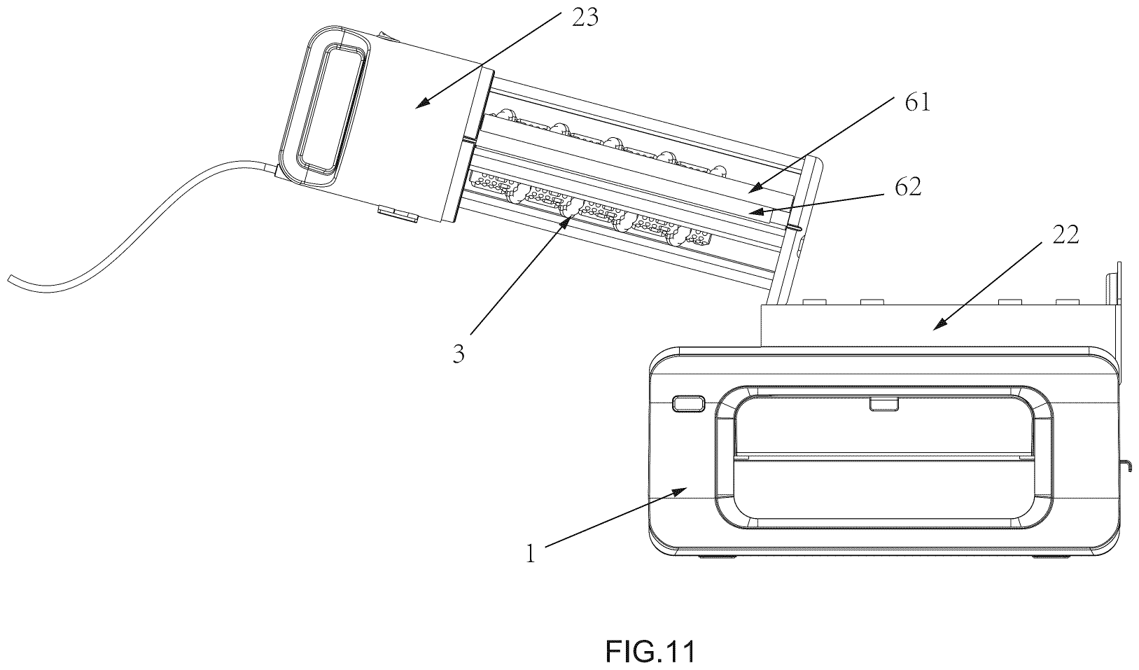

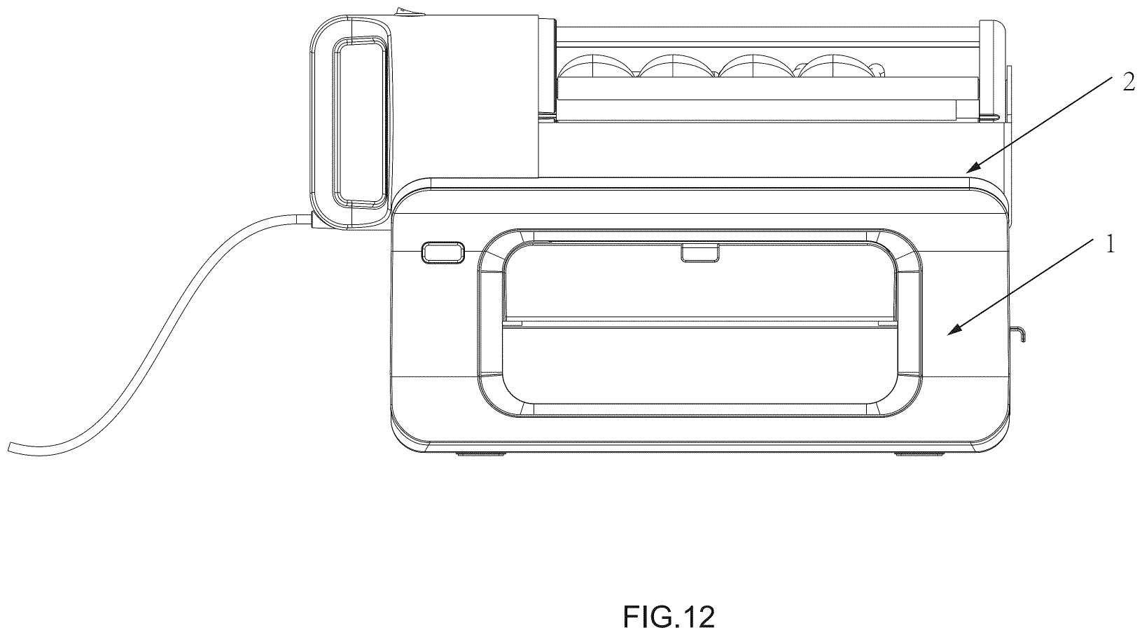

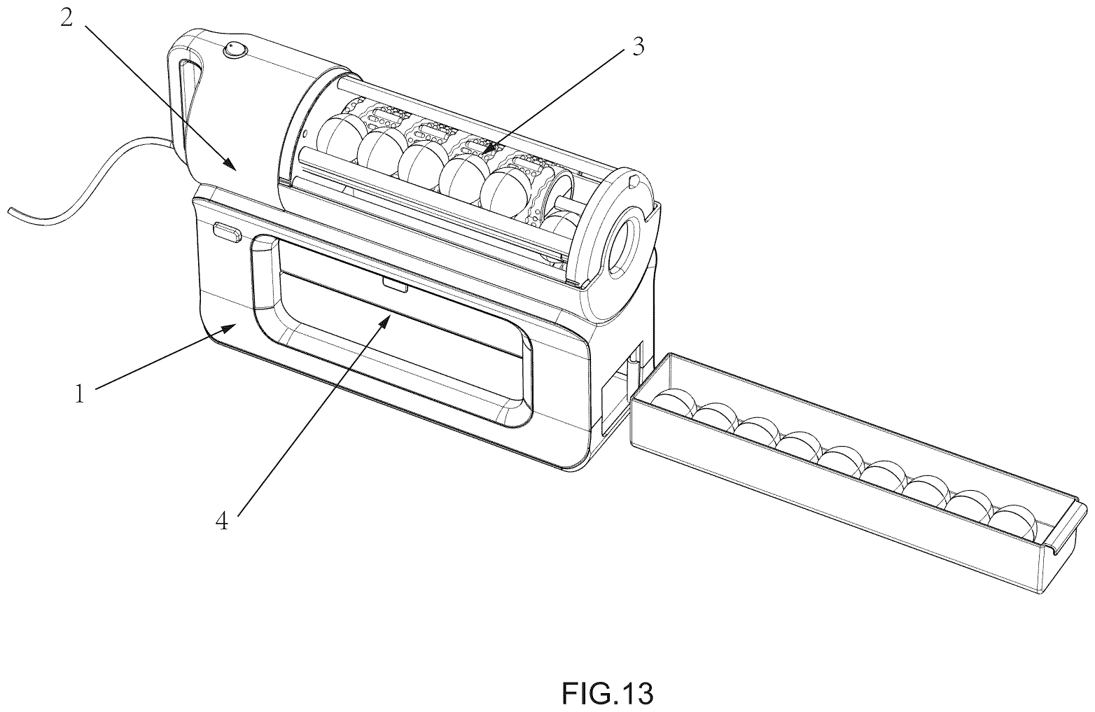

As shown in FIGS. 11a-11c, this scheme adopts a horizontal, desktop-type, and automatic egg skinning machine, which uses boiled and cooled eggs in cold water. The eggs are placed on the egg bracket 221 at the top, the machine power is started when a group of eggs are placed. The built-in shelling motor 30 drives the egg peeling roller 3 with the main turning and knocking function to rotate, and the internal gear drives the driving roller 62 of the auxiliary wheel to rotate. In the second step, the eggs are dropped into the egg peeling track one by one, and the egg skins are shed by the main and auxiliary rotating shafts. Moving from left to right, it automatically drops into the eggshell collecting box 4 and the egg collecting box 5 at the back. Moreover, the eggs are dragged out backward after the cabin is full, and the eggs are manually taken out for use. Manually dump it to the left eggshell collection box 4 after the eggshell collection box 4 is full. The machine adopts a split design. The hand-held handle and the egg working robot are independently in the drum device, and the hand-held split part can be washed and cleaned by independent water flow. The split and the main body allow for quick release of the quick release lock structure.

The foregoing is merely a preferred embodiment of the present invention, and the scope of implementation of the present invention is not limited thereto, that is, any simple equivalent change and modification made in accordance with the scope of the application for patent and the description of the present invention still fall within the scope of the present invention patent.

1. The automatic egg peeling machine is characterized in that it comprises a base and a shelling mechanism; wherein the shelling mechanism comprises a shell and an egg peeling roller, and the shell is installed on the base; wherein the shell is provided with an egg peeling track, and the upper end and the lower end of the shell are respectively provided with a feeding port and a discharging port communicating with the egg peeling track; wherein the egg peeling roller is installed on one side of the egg peeling track, the surface of the egg peeling roller is provided with a spiral conveying ridge, and the surface of the egg peeling roller is also provided with a plurality of crushing ridges and friction ridges, which are arranged between the conveying ridges.

2. The automatic egg peeling machine according to claim 1, characterized in that the egg peeling roller is composed of a shaft body and a sleeve; wherein the sleeve is set on the shaft body, and the two ends of the shaft body are provided with rotating shafts; wherein the surface of the outer sleeve is provided with the conveying convex pattern, crushing convex pattern, and friction convex pattern.

3. According to claim 1 or the automatic egg peeling machine, it is characterized in that the surface of the conveying convex pattern is in a continuous wave shape, the crushing convex pattern is in the form of a long strip, and the friction convex pattern is in the form of dense circular dots.

4. The automatic egg peeling machine according to claim 1, wherein the peeling mechanism further comprises a peeling motor installed in the housing and connected to the egg peeling roller.

5. The automatic egg peeling machine according to claim 4, wherein a plurality of passive rollers are further installed in the housing, and they are arranged on the egg peeling track and are used to support eggs.

6. The automatic egg peeling machine according to claim 4, wherein a driving roller is further installed in the housing, which is arranged on the other side of the egg peeling track opposite to the egg peeling roller, and the peeling motor is connected to and can drive the driving roller to rotate synchronously with the egg peeling roller.

7. The automatic egg peeling machine according to claim 1, characterized in that an elastic pressure plate is further installed in the shell, which is arranged above the egg peeling track; wherein the upper end of the elastic pressure plate is provided with a guide post, the guide post is provided with an anti-falling elastic block, the shell is provided with a guide groove matching the guide post, and a spring is also connected between the elastic pressure plate and the shell.

8. The automatic egg peeling machine according to claim 7, wherein the bottom surface of the elastic pressing plate is in an arc shape; the front end of the elastic pressing plate is in a tilted and inclined shape, and the bottom surface of the elastic pressing plate is further arranged with a plurality of evenly distributed particle points.

9. The automatic egg peeling machine according to claim 1, wherein the upper end of the shell is further provided with an egg bracket communicated with the feed port for discharging eggs to be peeled; a turning egg separator is arranged at the feeding port, the turning egg separator comprises a central shaft, two ends of the central shaft are respectively rotatably connected with the shell, and four turning plates are uniformly arranged on the circumference of the central shaft.

10. The automatic egg peeling machine according to claim 1, wherein the base is provided with an eggshell collecting box and an egg collecting box, and the bottom of the base is provided with a plurality of bedding.
